(19) United States
(12) Patent Application Publication
(10) Pub. No.: US 2026/0296857 A1
(43) Pub. Date: Oct. 1, 2026

(54) WORK MACHINE COMPRISING A REMOVABLE POWER SUPPLY UNIT

(71) Applicant: MANITOU BF, ANCENIS (FR)

(72) Inventor: David LEON, ANCENIS (FR)

(21) Appl. No.: 19/480,290

(22) PCT Filed: Apr. 29, 2024
(86) PCT No.: PCT/EP2024/061808

§ 371 Date: Oct. 30, 2025

(30) Foreign Application Priority Data
May 3, 2023 (FR) FR2304428

(51) Int. Cl. B66F 9/075; B60L 53/80; B66F 9/22

(52) U.S. Cl. CPC B66F 9/07572; B60L 53/80; B66F 9/22; B60L 2200/42

(57) ABSTRACT

The invention relates to a work machine (101) comprising a power supply unit (30), which comprises:
an electric actuation motor (60) separate from the propulsion motor (50);
a frame (40), the propulsion motor (50) and the actuation motor (60) being fixed to the frame (40).

The frame (40) is configured to be removably attachable to the frame (2) of the work machine (101) in an attachment position.

The power supply unit (30) in the attachment position is accessible from an outer side (A, B) of the chassis (2) so that it can be brought into the attachment position and removed from the attachment position from the outer side (A, B) of the chassis (2).

### TECHNICAL FIELD

The invention relates to the field of work machines. More specifically, the invention relates to a work machine comprising a removable power supply unit.

### TECHNOLOGICAL BACKGROUND

In the field of work machines, provision may be made for an element for supplying power to the work machine to be removable. “Removable” means that the element can be detached from the chassis of the work machine, for example in order to make this element easier to exchange.

For example, document EP 0 656 315 B1 discloses a combustion-engine-powered telescopic-arm lift truck in which the combustion engine is supported by two cross-members integral with one of the two longitudinal side members of the chassis. The combustion engine is thus removable and can be removed from the lift truck using a suitable working system.

However, the integration of environmental considerations (lower greenhouse gas emissions) and regulatory constraints (for warehouse handling, for example) has led to a growing demand for electrically powered, rather than combustion-engine-powered, work machines.

The Applicant Company has noted that, in this context, the work machine needs to be adapted so that some or all of the elements of the electric drive system can be removable, in particular because an electric motor does not have the same external dimensions as a combustion engine.

### SUMMARY

One idea underlying the invention is to propose a work machine of which the drive system is electrical, and in which elements of the electric drive system are removable. Another idea behind the invention is to ensure that the elements of the electric drive system are rendered removable so that the work machine is easier to assemble and/or to service.

According to one embodiment, the invention provides a work machine comprising:
a chassis comprising a front axle and a rear axle spaced in a longitudinal direction of the work machine, of the front axle and the rear axle at least one being a driven axle for propelling the chassis;
an actuator for actuating a handling member connected to the chassis or for actuating a stabilizing member or a canting member connected to the chassis; and
a power supply unit,
wherein the power supply unit comprises:
a propulsion motor, the propulsion motor being an electric motor and coupled to the driven axle;
an actuation motor separate from the propulsion motor, the actuation motor being an electric motor and coupled to the actuator; and
a frame, the propulsion motor and the actuation motor being attached to the frame,
wherein the power supply unit is configured in such a way that it can be removably attached to the chassis in an attachment position, the attachment position being located between the front axle and the rear axle in the longitudinal direction, and
wherein the power supply unit in the attachment position is accessible from an outer side of the chassis so that it can be brought into the attachment position and removed from the attachment position from the outer side of the chassis, the outer side of the chassis facing in a transverse direction of the work machine, the transverse direction being perpendicular to the longitudinal direction.

Thus, the power supply unit can be assembled separately from the work machine, then brought into the attachment position, and then attached to the chassis. This simplifies the assembly of the work machine, which is advantageous from an economic and industrial point of view. The work machine is also simple to service, since it is sufficient, in the opposite direction, to remove the power supply unit from the attachment position in order to perform maintenance thereon.

The power supply unit thus constitutes a modular element of the work machine, which is removable and simple to assemble and to service. In addition, the power supply unit provides electric drive to the work machine since the propulsion motor and the actuation motor are electric motors.

According to some embodiments, such a work machine may comprise one or more of the following features.

According to one embodiment, the propulsion motor is coupled to the drive axle via a mechanical transmission.

According to one embodiment, the mechanical transmission comprises a transfer box and a transmission shaft, the transfer box comprising an output shaft and an input shaft, the output shaft being coupled to the drive axle via the transmission shaft and being rotatable about a first axis of rotation included in a reference plane, the reference plane being parallel to the longitudinal direction and to the transverse direction, the input shaft being coupled to the propulsion motor and being rotatable about a second axis of rotation.

According to one embodiment, an angle between the reference plane and a straight line intersecting the first axis of rotation and the second axis of rotation is between 0° and 30°.

Thus, the transfer box may have a modest vertical footprint.

According to one embodiment, the second axis of rotation is included in the reference plane, in other words said angle is equal to 0°.

Thus, the vertical footprint of the transfer box is minimal.

According to one embodiment, the transfer box incorporates one or more reduction gear ratios.

According to one embodiment, the propulsion motor is attached directly to the frame. According to another embodiment, the propulsion engine is attached indirectly to the frame. For example, according to one embodiment, the transfer box has a casing fixed to the frame, and the propulsion motor is attached to the casing.

According to one embodiment, the power supply unit further includes attachment portions for removably attaching the frame to the chassis in the attachment position. Each of the attachment portions may be formed as one piece with the frame, or else attached directly to the frame, or else attached indirectly to the frame, i.e. attached to a power supply unit element that is attached to the frame.

According to one embodiment, the chassis comprises a first longitudinal side member and a second longitudinal side member, the first longitudinal side member and the second longitudinal side member being parallel to each other and extending parallel to the longitudinal direction.

According to one embodiment, in the attachment position, at least part of the frame projects beyond the first longitudinal side member in the transverse direction in a direction away from the second longitudinal side member, said outer side of the chassis facing in said direction away from the second longitudinal side member.

According to one embodiment, the power supply unit comprises three attachment portions, and the attachment portions comprise:
at least one outer attachment portion, the at least one outer attachment portion in the attachment position being located to the outside of the first longitudinal side member in the transverse direction in a direction away from the second longitudinal side member; and
at least one inner attachment portion, the at least one inner attachment portion in the attachment position being located on the opposite side, in the transverse direction, of the first longitudinal side member from the at least one outer attachment portion.

According to one embodiment, the attachment portions comprise:
two outer attachment portions, the outer attachment portions in the attachment position being located to the outside of the first longitudinal side member in the transverse direction in a direction away from the second longitudinal side member; and
one inner attachment portion, the inner attachment portion in the attachment position being located on the opposite side, in the transverse direction, of the first longitudinal side member from the outer attachment portions.

According to one embodiment, the outer attachment portions and/or the inner attachment portion are situated higher up than the propulsion motor and the actuation motor in a vertical direction of the work machine, the vertical direction being perpendicular to the longitudinal direction and to the transverse direction. This tends to facilitate the attachment of the frame to the chassis.

According to one embodiment, the inner attachment portion is attached to the transfer box casing.

According to one embodiment, the attachment portions comprise:
one outer attachment portion, the outer attachment portion in the attachment position being located to the outside of the first longitudinal side member in the transverse direction in a direction away from the second longitudinal side member; and
two inner attachment portions, the inner attachment portions in the attachment position being located on the opposite side, in the transverse direction, of the first longitudinal side member from the outer attachment portion.

According to one embodiment, the outer attachment portion and/or the inner attachment portions are situated higher up than the propulsion motor and the actuation motor in the aforementioned vertical direction of the work machine. This tends to facilitate the attachment of the frame to the chassis.

According to one embodiment, in the attachment position, the inner attachment portions are located between the first longitudinal side member and the second longitudinal side member in the transverse direction.

According to one embodiment, in the attachment position, the transfer box is located between the inner attachment portions in the longitudinal direction.

According to one embodiment, the work machine further comprises a cab for an operator of the work machine, the cab being disposed between the front axle and the rear axle in the longitudinal direction.

According to one embodiment, the cab projects beyond the second longitudinal side member in the transverse direction in a direction away from the first longitudinal side member. Thus, the cab projects out from the chassis on the opposite side from the above-mentioned outer side.

According to one embodiment, the cab projects from the first longitudinal side member in the transverse direction in said direction away from the second longitudinal side member. Thus, the cab projects out from the chassis on the above-mentioned outer side. According to one embodiment, in this case, the frame in the attachment position is situated lower down than the cab in the aforementioned vertical direction of the work machine.

According to one embodiment, each of the attachment portions includes a vibration damping element. For example, the vibration damping element comprises or consists of an elastomer cylinder block.

These vibration damping elements tend to damp vibrations generated in operation by the various elements of the power supply unit when the unit is attached to the chassis. In particular, the vibration damping elements can damp vibrations generated by the propulsion motor and/or by the actuation motor.

According to some embodiments, the power supply unit further includes some or all of the following:
an additional propulsion motor, the additional propulsion motor being an electric motor and coupled to the driven axle;
an auxiliary electric pump;
a heat exchanger;
at least one voltage converter for converting an electrical voltage delivered by an electrical power source on board the work machine, such as a battery, to at least one of the propulsion motor, the actuation motor and the additional propulsion motor.

The damping of vibrations by the vibration damping elements is all the more efficient the greater the total mass of the power supply unit. As a result, the greater the number of above-mentioned elements the power supply unit comprises, the more efficient this vibration damping is.

According to one embodiment, the heat exchanger is a plate exchanger.

According to one embodiment, the heat exchanger is configured to exchange heat between a liquid and a fluid in the gaseous state or in the liquid state.

According to one embodiment, the power supply unit comprises a hydraulic pump, and the actuation motor is coupled to the actuator via the hydraulic pump.

According to one embodiment, the heat exchanger is configured to exchange heat between a heat transfer liquid, notably water, and a hydraulic fluid driven by the hydraulic pump. According to one embodiment, in this case, the heat transfer liquid provides thermal regulation of at least one element of the power supply unit, notably at least one of the propulsion motor, the actuation motor, the additional propulsion motor, and said at least one voltage converter.

The heat transfer liquid can be driven by the above-mentioned auxiliary electric pump. According to one embodiment, the work machine further comprises an on-board heat exchanger, and the auxiliary pump is configured to drive the heat transfer liquid to this on-board heat exchanger. The on-board heat exchanger is configured to perform an exchange of heat between the heat transfer liquid and the ambient air.

According to one embodiment, the actuator is a hydraulic cylinder, and the hydraulic pump is configured to drive the hydraulic cylinder.

According to one embodiment, the work machine comprises a lifting arm articulated to the chassis, the lifting arm functioning as the aforementioned handling member.

According to one embodiment, the lifting arm extends parallel to the longitudinal direction, and the lifting arm is articulated to the longitudinal side members between the two longitudinal side members so as to be pivotable relative to the longitudinal side members about an axis of pivoting extending in the transverse direction.

According to one embodiment, the hydraulic cylinder is a lifting cylinder for lifting the lifting arm, a first end of the lifting cylinder being articulated to the chassis and a second end of the lifting cylinder being articulated to the lifting arm.

According to one embodiment, the aforementioned stabilizing member includes a stabilizing element intended to rest against the surface of the ground, and the hydraulic cylinder is coupled to the stabilizing element so as to deploy and retract the stabilizing element.

### BRIEF DESCRIPTION OF THE FIGURES

The invention will be better understood, and other aims, details, features and advantages thereof will become more clearly apparent over the course of the following description of several particular embodiments of the invention, which are given solely by way of nonlimiting illustration, with reference to the attached drawings.

FIG. 1A is a schematic plan view, from above, of a work machine comprising a power supply unit according to a first embodiment.

FIG. 1B is a schematic side view of the lifting arm of the work machine.

FIG. 1C is a schematic front view of the work machine.

FIG. 2 is a perspective view of a frame of the power supply unit of the work machine.

FIG. 3 is a perspective view of the power supply unit of the work machine, together with transmission shafts serving to propel the work machine.

FIG. 4 is a perspective view similar to FIG. 3, from another perspective angle.

FIG. 4A is a block diagram illustrating heat exchangers of the work machine.

FIG. 5 is a partial perspective view, from below, of the chassis of the work machine.

FIG. 6 is a partial perspective view similar to FIG. 5, from another perspective angle, illustrating the attachment of the frame of the power supply unit to the chassis of the work machine.

FIG. 7 is a schematic view similar to FIG. 1A, illustrating a mechanical transmission used to propel the work machine.

FIG. 8 is a schematic front view, illustrating the geometry of the mechanical transmission of FIG. 7.

FIG. 9 is a schematic view similar to FIG. 1A, illustrating different possibilities for attaching the frame of the power supply unit.

FIG. 10 is a schematic view similar to FIG. 9, illustrating various possibilities for attaching the frame of the power supply unit according to a variant embodiment.

FIG. 11 is a schematic plan view, from above, of a work machine comprising a power supply unit according to a second embodiment.

FIG. 12 is a schematic view similar to FIG. 11, illustrating different possibilities for attaching the frame of the power supply unit.

FIG. 13 is a schematic view similar to FIG. 12, illustrating various possibilities for attaching the frame of the power supply unit according to yet another variant embodiment.

### DESCRIPTION OF THE EMBODIMENTS

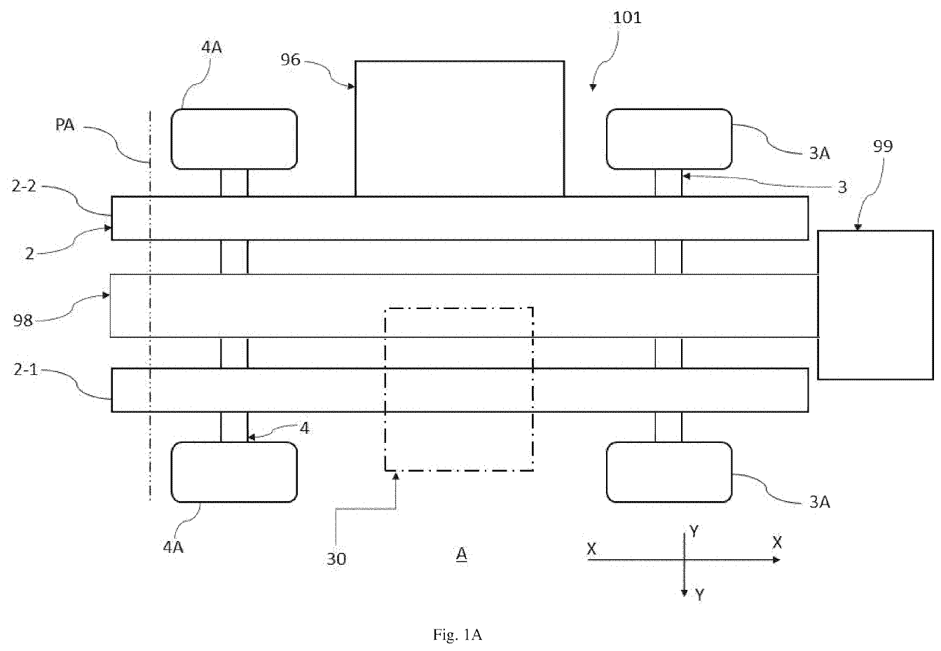

FIG. 1A shows a plan view, from above, of a work machine 101 (hereinafter referred to for convenience as “the machine 101”) according to a first embodiment.

The machine 101 comprises a chassis 2 that can be moved with respect to the surface of the ground S (cf. FIG. 1C). In order to propel the chassis 2, the machine 101 is equipped with a front axle 3 and a rear axle 4, which are spaced apart in the longitudinal direction X-X of the machine 101. The front axle 3 is provided here with two front wheels 3A disposed one on each side of the chassis 2 in the transverse direction Y-Y of the machine 101. Similarly, the rear axle 4 is equipped with two rear wheels 4A disposed one on each side of the chassis 2 in the transverse direction Y-Y of the machine 101.

The chassis 2 comprises two longitudinal side members 2-1 and 2-2. The longitudinal side members 2-1 and 2-2 are metal components that are generally flat and parallel to each other. The longest dimension of the longitudinal side members 2-1 and 2-2 extends in the longitudinal direction X-X. The longitudinal side members 2-1 and 2-2 are spaced apart in the transverse direction Y-Y.

The machine 101 is here in the form of a lift truck, and thus comprises a lifting arm 98. The lifting arm 98 extends in the longitudinal direction X-X. The lifting arm 98 is articulated to the longitudinal side members 2-1 and 2-2, between the longitudinal side members 2-1 and 2-2, so as to be pivotable relative to the longitudinal side members 2-1 and 2-2 about a horizontal axis of pivoting PA. The axis of pivoting PA is here parallel to the transverse direction Y-Y.

The lifting arm 98 may be embodied in various ways, notably in the form of several telescopic sections or, as a variant, in the form of a fixed-length arm. One end of the lifting arm 98, the opposite end from the axis of pivoting PA, may bear a modular tool holder 99 able to receive several types of working tool. What is meant by a working tool is, for example, a pair of forks, a bucket, a winch, a gripper, etc.

With reference to FIG. 1B, the machine 101 comprises a lifting cylinder 98A. The lifting cylinder 98A is used to pivot the lifting arm 98 around the axis of pivoting PA. For this purpose, a first end of the lifting cylinder 98A is articulated to the chassis 2 and a second end of the lifting cylinder 98A is articulated to the lifting arm 98, according to known techniques. In addition, the lifting arm 98 comprises a tilt cylinder 99A configured to pivot the modular tool holder 99 with respect to the lifting arm 98. For this purpose, a first end of the tilt cylinder 99A is articulated to the lifting arm 98 and a second end of the tilt cylinder 99A is articulated to the modular tool holder 99, according to known techniques. In a variant, the end of the lifting arm 98 bears a working tool in place of the modular tool holder 99. In this case, the tilt cylinder 99A can be used to pivot this working tool.

With reference to FIG. 1C, the machine 101 may comprise a cylinder 97A for deploying and retracting a stabilizing element, such as a bearing pad 97P, intended to rest against the surface of the ground S. For this purpose, a first end of the cylinder 97A is articulated to the chassis 2 (here to the longitudinal side member 2-1, for example) and a second end of the stabilizing cylinder 97A is articulated to the bearing pad 97P, according to known techniques.

Returning to FIG. 1A, the machine 101 further comprises a cab 96 disposed between the front axle 3 and the rear axle 4 in the longitudinal direction X-X. The cab 96 is configured so that an operator of the machine 101 can be accommodated in the cab 96. The cab 96 comprises the elements necessary for the operator to control the machine 101. The cab 96 projects from the longitudinal side member 2-2 in the transverse direction Y-Y in a direction away from the first longitudinal side member 2-1.

The machine 101 further comprises a power supply unit 30 (hereinafter referred to for convenience as “the unit 30”). As will be described in detail below, the unit 30 supplies the power necessary to propel the machine 101 via the front axle 3 and/or the rear axle 4, and to actuate some or all of the cylinders 97A, 98A, 99A. The unit 30 comprises a frame 40 configured so as to be able to be removably attached to the chassis 2, and various elements attached to the frame 40 as will be described below.

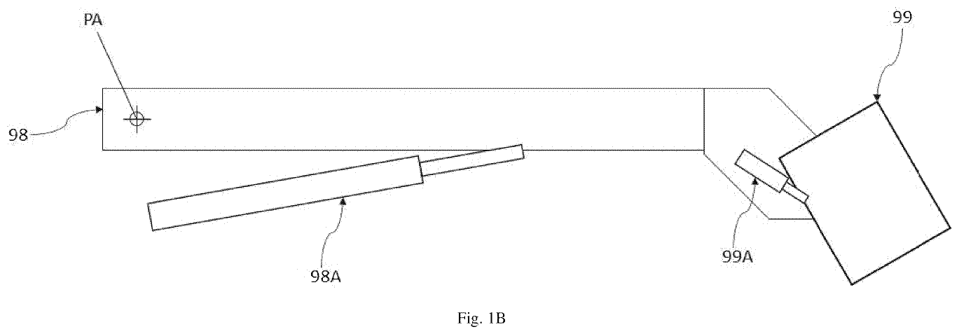

FIG. 2 shows the frame 40 taken in isolation. The frame 40 comprises a support structure 45. The support structure 45 is provided so that elements of the unit 30 can be attached to the support structure 45, for example fixed to the support structure 45. The support structure 45 may also be shaped so as to support some or all of these elements, for example so as to support them from below in the vertical direction Z-Z of the machine 101. Attachment portions 41, 42, 43 are attached directly or indirectly to the support structure 45, as will be described in detail below.

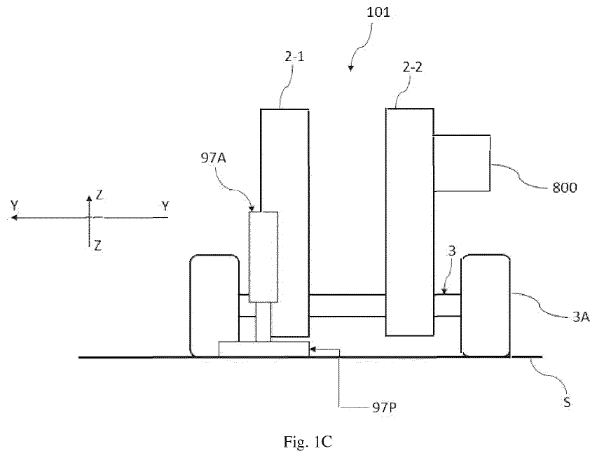

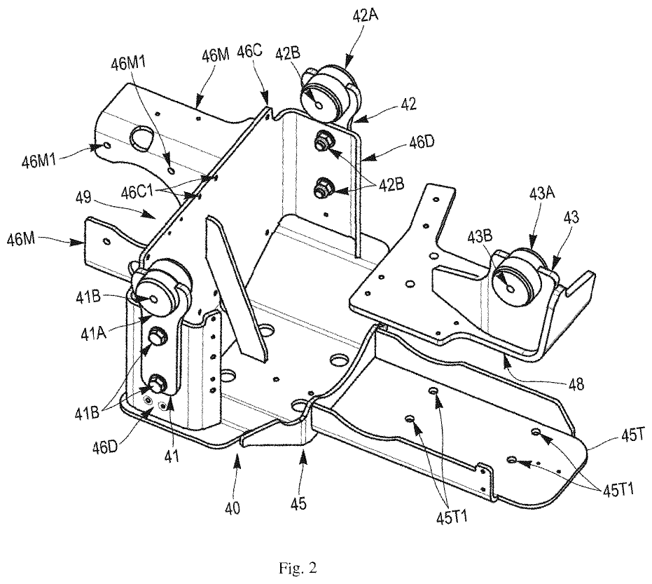

FIG. 3 and FIG. 4 show various elements of the unit 30 which are attached to the support structure 45 of the frame 40. The unit 30 comprises a propulsion motor 50, an actuation motor 60 and a transfer box 71.

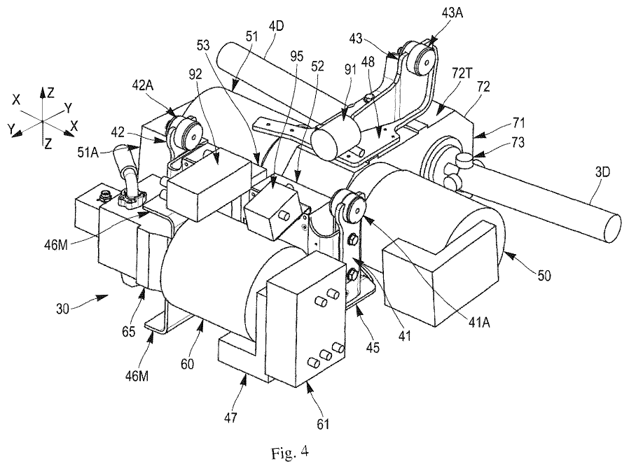

The transfer box 71 is attached to a casing support portion 45T (cf. FIG. 2, FIG. 3, FIG. 6) of the support structure 45. In the example shown, the casing support portion 45T is flat and has through holes 45T1 (cf. FIG. 2), the through holes 45T1 allowing the casing 72 of the transfer box 71 to be attached to the casing support portion 45T by means of fastener elements, such as screws for example.

In the example shown, the propulsion motor 50 is fixed to the casing 72 of the transfer box 71. In a variant, the propulsion motor 50 may be attached to the support structure 45, or else it may be attached to the support structure 45 and to the casing 72.

The propulsion motor 50 is an electric motor. The propulsion motor 50 therefore requires an electrical voltage in order to operate. For this purpose, the unit 30 preferably comprises a voltage converter 52 (cf. FIG. 3, FIG. 4). The voltage converter 52 converts an electrical voltage delivered by an electrical power source on board the machine 101, such as a battery, and delivers the electrical voltage thus converted to the propulsion motor 50. For example, the voltage converter 52 is an inverter, that is to say a DC-AC converter. The voltage converter 52 is attached to a first power supply attachment portion 46C (cf. FIG. 2). In the example shown, the first power supply attachment portion 46C comprises through holes 46C1 (cf. FIG. 2), the through holes 46C1 allowing the voltage converter 52 to be attached to the first power supply attachment portion 46C by means of fastener elements, such as screws for example. The reference 50A (cf. FIG. 3, FIG. 4 and FIG. 6) designates a cover or casing attached to the propulsion motor 50 and intended to protect the electric cables supplying power to the propulsion motor 50.

The unit 30 may further comprise an additional propulsion motor 51 (cf. FIG. 3, FIG. 6). The additional propulsion motor 51 is attached to the casing 72 and/or to the support structure 45 in a similar manner to the propulsion motor 50. The additional propulsion motor 51 is an electric motor. The unit 30 preferably comprises an additional voltage converter 53 (cf. FIG. 3, FIG. 4). The additional voltage converter 53 is attached to the first power supply attachment portion 46C in a similar manner to the voltage converter 52. The reference 51A (cf. FIG. 3, FIG. 4 and FIG. 6) designates a cover or casing attached to the additional propulsion motor 51 and intended to protect the electric cables supplying power to the additional propulsion motor 51.

The actuation motor 60 (cf. FIG. 3, FIG. 4) is attached to two motor attachment portions 46M (cf. FIG. 2, FIG. 4). In the example shown, the motor attachment portions 46M have through holes 46M1 (cf. FIG. 2), the through holes 46M1 allowing the actuation motor 60 to be attached to the motor attachment portion 46M. The motor attachment portions 46M face each other so as to leave between them a clear passage space 49 (cf. FIG. 2), the passage space 49 allowing an output shaft of the actuation motor 60 to be coupled to a hydraulic pump 65 (cf. FIG. 4).

The actuation motor 60 is an electric motor. The actuation motor 60 therefore requires an electrical voltage in order to operate. For this purpose, the unit 30 preferably comprises a voltage converter 61 (cf. FIG. 3, FIG. 4, FIG. 6). The voltage converter 61 converts an electrical voltage delivered by an electrical power source on board the machine 101, such as a battery, and delivers the electrical voltage thus converted to the actuation motor 60. For example, the voltage converter 61 is an inverter, that is to say a DC-AC converter. The voltage converter 61 is attached to a second power supply attachment portion 47 (cf. FIG. 3, FIG. 4). In the example shown, the second power supply attachment portion 47 is fastened to the support structure 45. The actuation motor 60 can also be attached to the second power supply attachment portion 47.

As mentioned above, attachment portions 41, 42, 43 are attached directly or indirectly to the support structure 45. In the example shown, the attachment portions 41, 42 are fastened by screws 41B, 42B to attachment flanges 46D (cf. FIG. 2), the attachment flanges 46D being formed as one piece with the first power supply attachment portion 46C. The attachment portion 43 comprises an attachment plate 48 (cf. FIG. 2, FIG. 3, FIG. 4), the attachment plate 48 here being fastened to an upper face 72T (cf. FIG. 4) of the casing 72 of the transfer box 71.

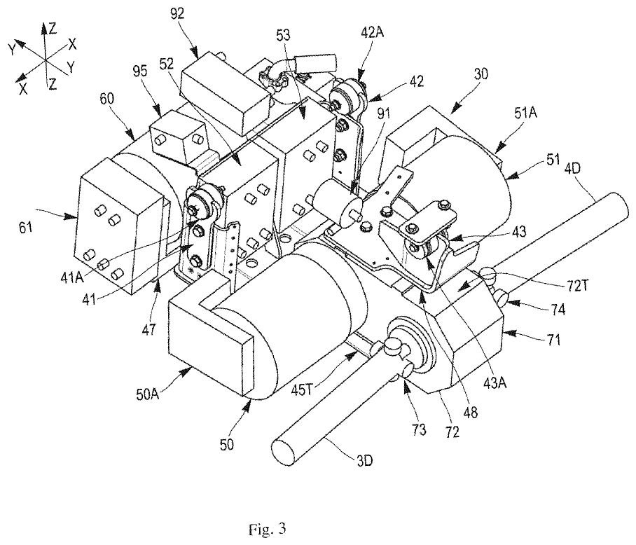

In FIG. 5 and FIG. 6, the chassis 2 of the machine 101 is partially depicted, in perspective from below (i.e. from the bottom upward in the vertical direction Z-Z). It can be seen that the chassis 2 comprises two cross-members 11, 12. The cross-members 11, 12 are spaced apart in the longitudinal direction X-X. The cross-members 11, 12 extend in the transverse direction Y-Y. Preferably, the cross-members 11, 12 are parallel to each other. Each of the cross-members 11, 12 extends between the longitudinal side members 2-1, 2-2 and passes through the longitudinal side member 2-1 so as to project beyond the longitudinal side member 2-1 in the transverse direction Y-Y in a direction away from the longitudinal side member 2-2.

The cross-member 11 comprises a yoke 111. The yoke 111 is composed of two webs 112, 113. The webs 112, 113 are parallel to each other and spaced apart from each other in the longitudinal direction X-X. The webs 112, 113 have mutually aligned through holes 112F, 113F.

Similarly, the cross-member 12 comprises a yoke 121. The yoke 121 is composed of two webs 122, 123. The webs 122, 123 are parallel to each other and spaced apart from each other in the longitudinal direction X-X. The webs 122, 123 have mutually aligned through holes 122F, 123F.

A spacer 13 (cf. FIG. 5 and FIG. 6) extending in the longitudinal direction X-X may be attached to the cross-members 11, 12 between the cross-members 11, 12. The spacer 13 tends to stiffen the cross-members 11, 12 and therefore improve the attachment of the unit 30, which will be described below.

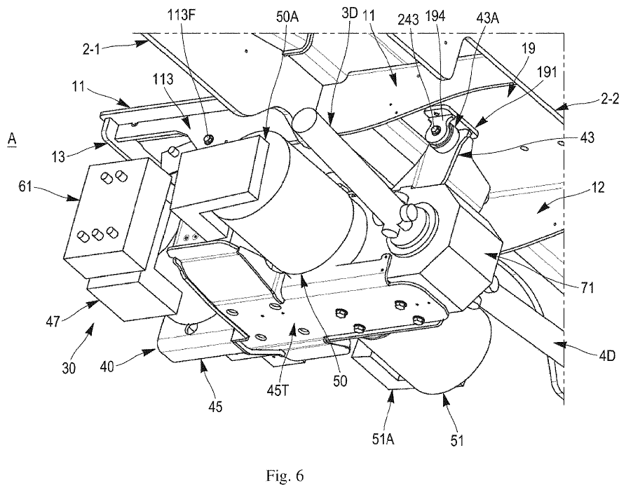

The chassis 2 further comprises a retaining plate 19 (cf. FIG. 5, FIG. 6, FIG. 9). The retaining plate 19 extends between the longitudinal side members 2-1, 2-2 and between the cross-members 11, 12. For example, the retaining plate 19 is fastened to the longitudinal side members 2-1, 2-2. The retaining plate 19 comprises a yoke 191. The yoke 191 is composed of two webs 194, 195. The webs 194, 195 are parallel to each other and spaced apart from each other in the longitudinal direction X-X. The webs 194, 195 have mutually aligned through holes 194F, 195F.

With reference to FIG. 6, it can be seen that the attachment portion 43 and the yoke 191 are dimensioned so that one end of the attachment portion 43 can be received between the webs 194, 195. The attachment portion 43 is attached to the retaining plate 19 via the yoke 191 by means of a pin 243 (cf. FIG. 6) or another similar element, the pin 243 being received in a through hole 43B (cf. FIG. 2) provided for this purpose in the attachment portion 43.

It can also be seen in FIG. 2 and FIG. 6 that the attachment portion 43 comprises a vibration damping element 43A, for example of the elastomer cylinder-block type. The vibration damping element 43A is positioned between the webs 194, 195 of the yoke 191 when the attachment portion 43 is attached to the yoke 191.

The attachment portions 41, 42 are attached in a similar manner to the cross-members 11, 12 via the yokes 111, 112. The attachment portions 41, 42 comprise vibration damping elements 41A, 42A similar to the vibration damping element 43A and through holes 41B, 42B similar to the through hole 43B.

The yokes 111, 121, 191 project downwards in the vertical direction Z-Z, while the attachment portions 41, 42, 43 are situated higher up than the propulsion motor 50, the additional propulsion motor 51, and the actuation motor 60. With reference to FIG. 5 and to FIG. 6, it will be appreciated that in this way it is easy to attach the unit 30 to the chassis 2. Indeed, it is sufficient to bring the unit 30 in from an outer side A of the chassis 2 (cf. FIG. 1A and FIG. 6) to its attachment position shown in FIG. 6, by a translational movement in the transverse direction Y-Y followed by a translational movement in the vertical direction Z-Z, and then attach the attachment portions 41, 42, 43 to the yokes 111, 121, 191 in the way that has just been described. The longitudinal side member 2-1 may have a lower cut-out (indicated by the marks 2-1U in FIG. 5) to make it easier to bring the unit 30 into its attachment position.

It will also be appreciated that the unit 30 can be assembled separately from the machine 101, then attached to the chassis 2 in the way that has just been described. Then, to complete the installation of the unit 30 on the machine 101, it is sufficient to make the necessary connections (electrical cables, hydraulic lines, control cables, etc.) between the unit 30 and the machine 101. This simplifies the assembly of the machine 101, which is advantageous from an economic and industrial point of view. The machine 101 is also simple to service since it is merely necessary, in the reverse direction, to undo the connections between the unit 30 and the machine 101 and to undo the attachment of the unit 30 to the chassis 2 in order to remove the unit 30 and service it.

The unit 30 thus constitutes a modular element of the machine 101, which is removable and simple to assemble and to service. The unit 30 also constitutes a modular element providing electric drive of the machine 101 since the motors 50 and 60 and, where applicable the motor 51, are electric motors.

The vibration damping elements 41A, 42A, 43A tend to damp the vibrations generated in operation by the various elements of the unit 30 when the latter is attached to the chassis 2. This damping of vibrations by the vibration damping elements 41A, 42A, 43A is all the more efficient the greater the total mass of the unit 30. Now, the unit 30 groups a large number of components (namely the motors 50, 51, 61, the voltage converters 52, 53, 62, the hydraulic pump 65, the transfer box 71, etc.) together on the frame 40. It will therefore be appreciated that the unit 30 also provides very satisfactory damping of the vibrations generated during operation.

The hydraulic pump 65 can be integrated into a hydraulic circuit of the machine 101 in order to supply hydraulic fluid under pressure to the lifting cylinder 98A and/or to the tilt cylinder 99A (cf. FIG. 1B) and/or to the stabilizing cylinder 97A (cf. FIG. 1C). As a variant, the hydraulic pump 65 can supply hydraulic fluid under pressure to yet other hydraulic actuators of the machine 101, such as a cylinder that telescopes the lifting arm 98, a cylinder to compensate for the lifting arm 98 and associated with the lifting cylinder 98A, a cylinder that corrects for canting, etc.

With reference to FIG. 3 and to FIG. 4, further elements may be provided in the unit 30 to allow even more elements of the machine 101 to be assembled in the unit 30 and/or to increase the total mass of the unit 30 still further.

In the example shown, with reference to FIGS. 3, 4 and 4A, a heat exchanger 92 is provided for the thermal regulation of various elements of the unit 30 and/or of the machine 101. The heat exchanger 92 is, for example, a plate exchanger. The heat exchanger 92 performs an exchange of heat between, on the one hand, a liquid and, on the other hand, another fluid in the gaseous state or in the liquid state. A valve 95 is provided to regulate the arrival of the liquid from and to the heat exchanger 92. The lines carrying the liquid are not shown so as not to overload the drawing. The heat exchanger 92 is here fastened to one of the motor attachment portions 46M. The valve 95 is here fastened to the first power supply attachment portion 46C.

In the example shown, with reference to FIG. 4A, the heat exchanger 92 performs an exchange of heat between, on the one hand, water W serving as the heat transfer liquid, and, on the other hand, the hydraulic fluid H of the hydraulic circuit of the machine 101. The hydraulic fluid H may, for example, be hydraulic oil or another suitable hydraulic fluid. The water W can be conveyed to and from the voltage converters 52, 53 and/or 62, and/or to and from the motors 50, 51, 60, and/or to and from other elements of the unit 30 requiring thermal regulation, for example cooling. In other words, the heat exchanger 92 performs an exchange of heat between the hydraulic fluid H and the water W used for the thermal regulation of elements of the unit 30.

In the example shown, the unit 30 further comprises an auxiliary electric pump 91. The auxiliary pump 91 is here fastened to the fixing plate 48. The auxiliary pump 91 circulates the water W. The auxiliary pump 91 can drive the water W to a heat exchanger 800 (cf. FIG. 1C and FIG. 4A) mounted on the machine 101, for example secured to the chassis 2. The heat exchanger 800 performs an exchange of heat between, on the one hand, the water W and, on the other hand, the ambient air C. It is of course understood that the circulation of the water W can be implemented in various ways. In addition, the heat exchanger 800 can also be used for the thermal regulation of various elements, not shown, of the machine 101.

As a variant, the auxiliary pump 91 may be omitted, or the heat exchanger 92 and the valve 95 may be omitted. As a variant, the auxiliary pump 91 and/or the heat exchanger 92 and/or the valve 95 may be positioned and/or attached differently from the example shown.

As a variant, still other elements of the machine 101 may be provided on the unit 30.

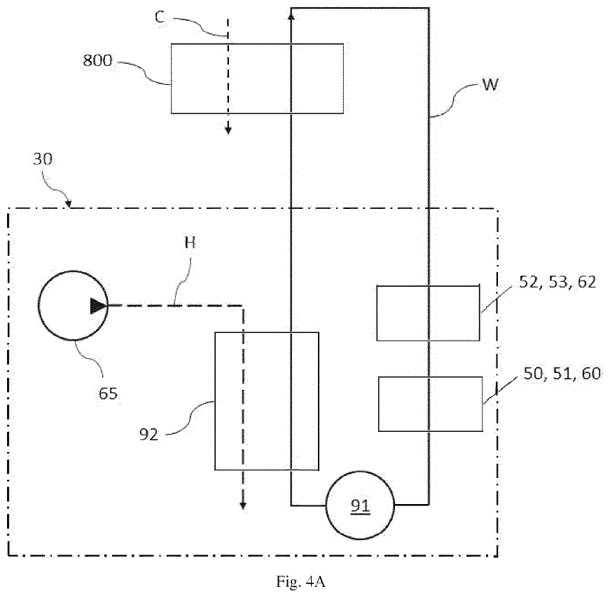

FIG. 7 is a schematic view similar to FIG. 1A, illustrating an example of a mechanical transmission 70 used to propel the machine 101. The mechanical transmission 70 comprises transmission shafts 3D, 4D. With reference to FIG. 3, to FIG. 4 and to FIG. 6, the transmission shafts 3D, 4D are each coupled to an output shaft of the transfer box 71, in this case via universal joints 73, 74 such as cardan joints. Returning to FIG. 7, the transmission shaft 3D is coupled to one input of a differential 3B of the front axle 3, here via a universal joint 3C such as a cardan joint. Similarly, the transmission shaft 4D is coupled to one input of a differential 4B of the rear axle 4, here via a universal joint 4C such as a cardan joint. In operation, the propulsion motor 50 (and the additional propulsion motor 51, if present) thus drives the front axle 3 and the rear axle 4.

It is emphasized here that the transfer box 71 can, if desired, incorporate one or more reduction ratios as required. In addition, with reference to FIG. 3, FIG. 4, FIG. 6 and FIG. 7, it will be understood that the universal joints 3C, 73, 74, 4C allow a certain freedom in the positioning of the transfer box 71, and therefore in the positioning of the unit 30, with respect to the axles 3, 4.

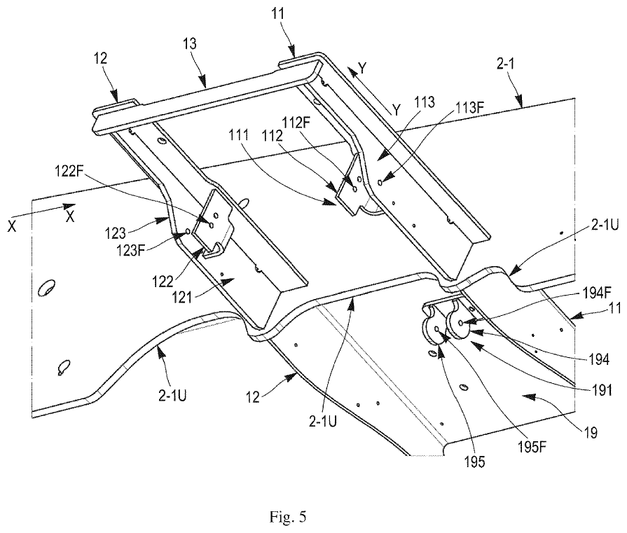

A preferred spatial orientation of the transfer box 71 is now described with reference to FIG. 7 and to FIG. 8. In FIG. 7, the broken line R2 indicates the axis of rotation of the output shaft of the propulsion motor 50, and the broken line R1 indicates the axis of rotation of the output shaft of the transfer box 71 coupled to the transmission shaft 3D. Given the axis of rotation R1, a horizontal reference plane P (i.e. a plane parallel to the longitudinal direction X-X and to the transverse direction Y-Y) and including the axis of rotation R1 is defined. Given the reference plane P, an angle β (cf. FIG. 8) between the plane P and a straight line D intersecting the axes of rotation R1 and R2 is defined. The absolute value of β is preferably between 0° and 30° inclusive. It is emphasized here that although FIG. 8 shows the axis of rotation R2 as being situated above (in the vertical direction Z-Z) the reference plane P, the axis of rotation R2 may also be situated below the reference plane P, as long as the absolute value of β is between 0° and 30° inclusive.

With reference to FIG. 7 and to FIG. 8, it will be appreciated that when the absolute value of β is between 0° and 30° inclusive, the transfer box 71 may have a moderate vertical footprint.

More preferably still, β is equal to 0°, that is to say that the axes of rotation R1 and R2 are both included in the horizontal reference plane P. In that case, the vertical footprint of the transfer box 71 is minimal, as will be appreciated with reference to FIGS. 3, 4 and 6 which depict a case where β is equal to 0°.

The same principle applies to the axis of rotation R1S of the output shaft of the transfer box 71 coupled to the transmission shaft 4D. Preferably, and as shown schematically in FIG. 7, the axis of rotation R1S coincides with the axis of rotation R1.

Furthermore, the same principle is applicable to the additional propulsion motor 51 even though this is not shown in FIG. 7 and FIG. 8. Preferably, and as can be seen in FIG. 3, FIG. 4 and FIG. 6, the propulsion motor 50 and the additional propulsion motor 51 are aligned, so that the axis of rotation of the output shaft of the additional propulsion motor 51 coincides with the axis of rotation R2.

The mechanical transmission 70 described above is only one example. Numerous other configurations for the mechanical transmission 70 are possible. For example, in a variant, of the front axle 3 and the rear axle 4 only one may be a driven axle; in that case, the transmission shaft 3D or 4D corresponding to the non-driven axle may be omitted. According to another variant, the front axle 3 and the rear axle 4 are both driven axles, the transfer box 71 drives a transfer box secured to one of either the front axle 3 or the rear axle 4, and this transfer box drives the other of either the front axle 3 or the rear axle 4, for example via a longitudinal transmission shaft.

The above-described attachment of the frame 40 to the chassis 2 is only one example. The frame 40 can be attached to the chassis 2 in various ways.

In the example shown in FIGS. 2, 3, 4 and 6, the attachment portion 43 comprises a fixing plate 48 fastened to an upper face 72T of the casing 72 of the transfer box 71. In a variant, the attachment portion 43 may be fastened directly to the support structure 45 and not to the casing 72 of the transfer box 71.

In the example shown in FIG. 5 and FIG. 6, the attachment portion 43 is attached (via the yoke 191) to the chassis 2 closer to the longitudinal side member 2-1 than to the longitudinal side member 2-2 in the transverse direction Y-Y. As a variant, as shown in FIG. 9, the attachment portion 43 can be attached to the chassis 2:
equidistant from the longitudinal side member 2-1 and the longitudinal side member 2-2 in the transverse direction Y-Y;
or else beyond the longitudinal side member 2-2 in the transverse direction Y-Y in a direction away from the longitudinal side member 2-1, for example lower down than the cab 96 in the vertical direction Z-Z.

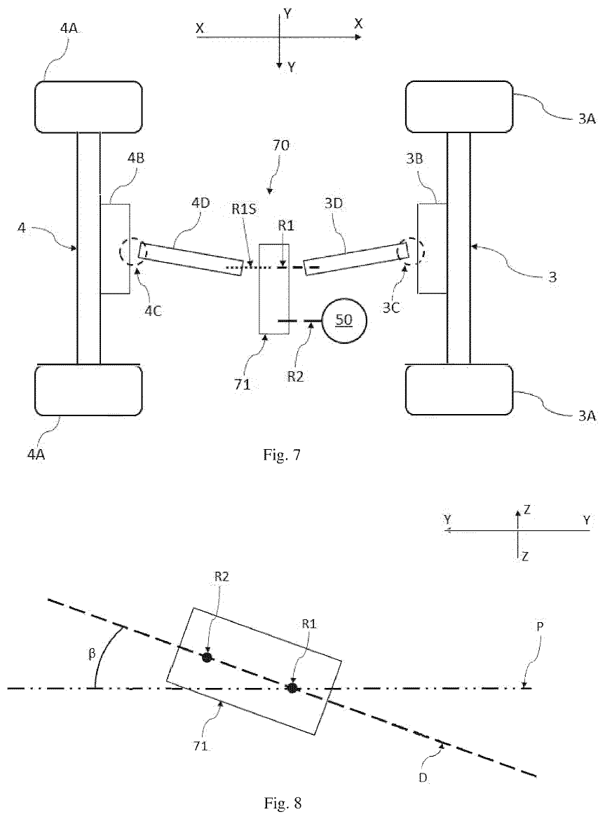

In another embodiment variant shown in FIG. 10, the frame 40 can be attached to the chassis 2 by:
two attachment portions 445, 446 similar to the attachment portions 41, 42 but attached to the chassis 2 between the longitudinal side members 2-1, 2-2 in the transverse direction Y-Y (for example equidistant from the longitudinal side member 2-1 and from the longitudinal side member 2-2 in the transverse direction Y-Y), or else attached to the chassis 2 beyond the longitudinal side member 2-2 in the transverse direction Y-Y in a direction away from the longitudinal side member 2-1, for example lower down than the cab 96 in the vertical direction Z-Z; and
one attachment portion 444 similar to the attachment portion 43, but attached to the chassis 2 beyond the longitudinal side member 2-1 in the transverse direction Y-Y in a direction away from the longitudinal side member 2-2.

With reference to FIG. 10, it will be appreciated that by providing for the two attachment portions 445, 446 to be spaced apart in the longitudinal direction X-X between the longitudinal side members 2-1, 2-2, it is easy to leave enough clear space for the transfer box 71 on the frame 40 between the two attachment portions 445, 446.

In the examples described so far, in the attachment position of the unit 30, at least a part of the frame 40 projects out from the longitudinal side member 2-1 in the transverse direction Y-Y in a direction away from the longitudinal side member 2-2. However, other positions are possible.

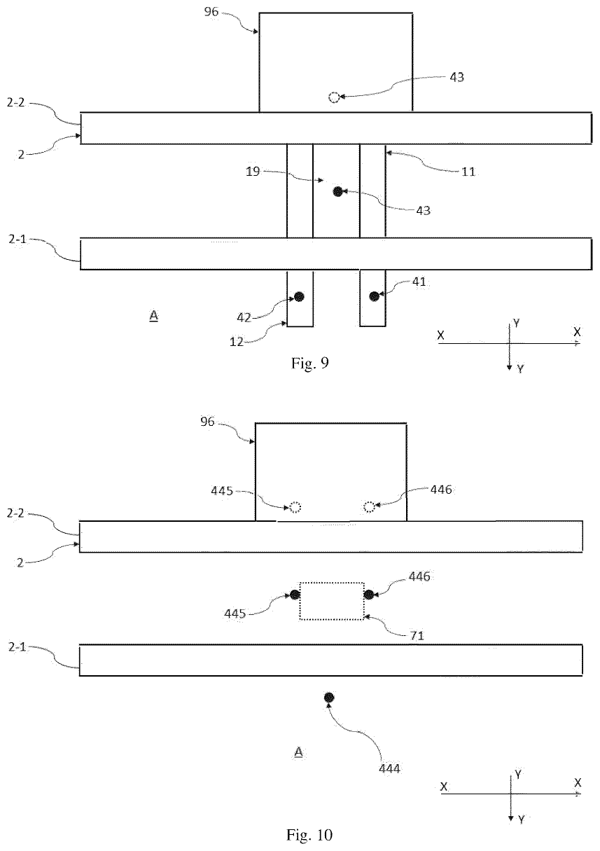

FIG. 11 shows a plan view, from above, of a work machine 201 (hereinafter referred to for convenience as “the machine 201”) according to a second embodiment. In this figure, the elements that are similar or identical to those described above bear the same reference symbols and are not described again.

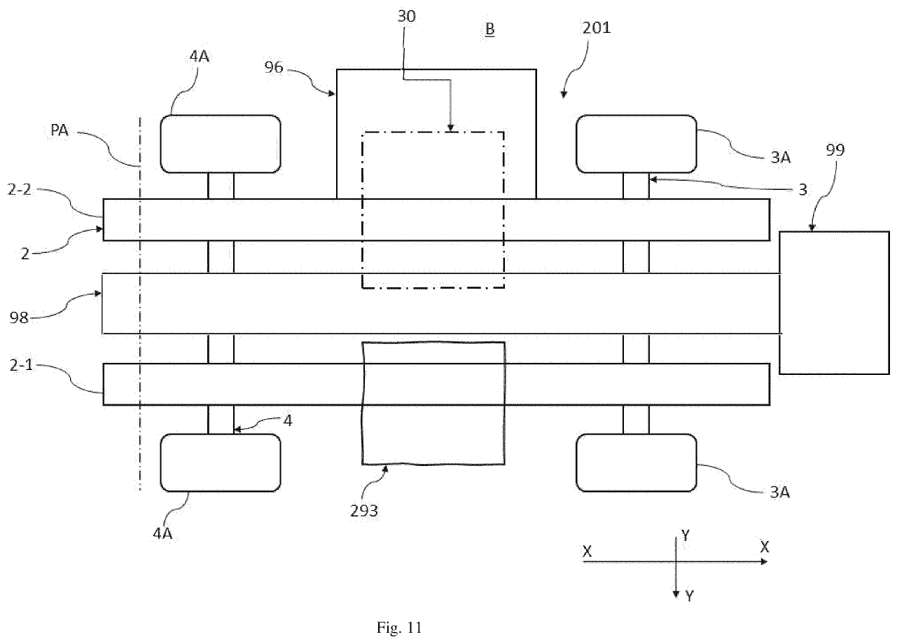

The machine 201 differs from the machine 101 in that, in the attachment position of the unit 30, at least a part of the frame 40 projects out from the longitudinal side member 2-2 in the transverse direction Y-Y in a direction away from the longitudinal side member 2-1. For that, as depicted in FIG. 12, each of the cross-members 11, 12 extends between the longitudinal side members 2-1, 2-2 and passes through the longitudinal side member 2-2 so as to project beyond the longitudinal side member 2-1 in the transverse direction Y-Y in a direction away from the longitudinal side member 2-1.

The frame 40 in the attachment position may be situated lower down than the cab 96 in the vertical direction Z-Z. In that case, the cross-members 11, 12 can extend below the cab 96.

The frame 40 is attached to the chassis 2 by:
two attachment portions 541, 542 similar to the attachment portions 41, 42 and attached respectively to the cross-members 11, 12; and
one attachment portion 543 similar to the attachment portion 43 and attached to the retaining plate 19.

The principle of this attachment is similar to that described above, except that the unit 30 is brought in from the outer side B of the chassis 2 corresponding to the cab 96. This principle is therefore not described again in detail.

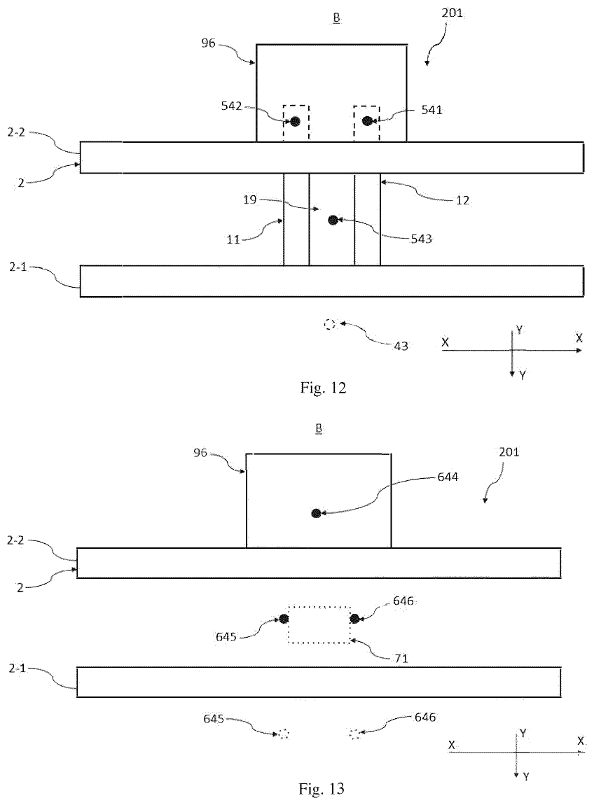

In another embodiment variant shown in FIG. 13, the frame 40 can be attached to the chassis 2 by means of attachment portions 644, 645, 646 positioned as follows:
two attachment portions 645, 646 similar to the attachment portions 445, 446 are attached to the chassis 2 between the longitudinal side members 2-1, 2-2 in the transverse direction Y-Y (for example equidistant from the longitudinal side member 2-1 and from the longitudinal side member 2-2 in the transverse direction Y-Y), or else attached to the chassis 2 beyond the longitudinal side member 2-1 in the transverse direction Y-Y in a direction away from the longitudinal side member 2-2; and
one attachment portion 644 similar to the attachment portion 444 is attached to the chassis 2 beyond the longitudinal side member 2-2 in the transverse direction Y-Y in a direction away from the longitudinal side member 2-1, for example lower down than the cab 96 in the vertical direction Z-Z.

In this variant embodiment also, it is easy to leave sufficient clear space for the transfer box 71 on the frame 40 between the two attachment portions 445, 446.

Returning to FIG. 11, since the cab 96 and the unit 30 are on the same side of the chassis 2 in the transverse direction Y-Y, a counterweight 293 may be provided on the other side of the chassis 2 in the transverse direction Y-Y in order to better balance the machine 201 laterally. The counterweight 293 may be formed by an abovementioned on-board electrical power source of the machine 201, such as a battery, a generator set, a fuel cell and/or by another on-board element of the machine 201 and/or by non-functional ballast.

It is quite obvious that in the machine 101 as in the machine 201, the respective positions, in the transverse direction Y-Y, of the longitudinal side members 2-1, 2-2 and of the elements associated therewith can be symmetrically interchanged. Purely by way of explanation, in FIG. 1A, the longitudinal side member 2-2 can be positioned in the place of the longitudinal side member 2-1 and vice versa; the cab 96 then projects beyond the longitudinal side member 2-2 towards the lower edge of the page, while the frame 40 of the unit 30 projects from the longitudinal side member 2-1 towards the upper edge of the page.

Furthermore, each of the attachment portions 41, 42, 43, 444, 445, 446, 544, 545, 546, 644, 645, 646 can assume a large number of shapes as long as it attaches the frame 40 to the chassis 2. However, it is preferable for the attachment portions 41, 42, 43, 444, 445, 446, 544, 545, 546, 644, 645, 646 to comprise vibration damping elements similar to the vibration damping elements 41A, 42A, 43A described above.

As a variant, the machine 101 or 201 may assume forms other than a lifting truck, such as a cherry picker, an excavator, etc. In this case also, the hydraulic pump 65 is integrated into a hydraulic circuit of the machine 101 or 201 in order to supply hydraulic fluid under pressure to one or more actuation cylinders of the machine 101 or 201.

Although the invention has been described in connection with a number of particular embodiments, it is quite obvious that it is not in any way restricted to these and that it can comprise any technical equivalents of the means described and combinations thereof where these fall within the scope of the invention.

The use of the verbs “comprise”, “include” or “have” and the conjugated forms thereof does not exclude the presence of elements or steps other than those listed in a claim.

In the claims, any reference sign between parentheses should not be interpreted as a limitation on the claim.

1. A work machine (101; 201) comprising:
a chassis (2) comprising a front axle (3) and a rear axle (4) spaced in a longitudinal direction (X-X) of the work machine (101; 201), of the front axle (3) and the rear axle (4) at least one being a driven axle for propelling the chassis (2);
an actuator for actuating a handling member connected to the chassis (2) or for actuating a stabilizing member connected to the chassis (2); and
a power supply unit (30),
wherein the power supply unit (30) comprises:
a propulsion motor (50), the propulsion motor (50) being an electric motor and coupled to the driven axle;
an actuation motor (60) separate from the propulsion motor (50), the actuation motor (60) being an electric motor and coupled to the actuator; and
a frame (40), the propulsion motor (50) and the actuation motor (60) being attached to the frame (40),
wherein the power supply unit (30) further comprises attachment portions (41, 42, 43; 444, 445, 446; 541, 542, 543; 644, 645, 646) for removably attaching the frame (40) to the chassis (2) so as to removably attach the power supply unit (30) to the chassis (2) in an attachment position, the attachment position being located between the front axle (3) and the rear axle (4) in the longitudinal direction (X-X), and
wherein the power supply unit (30) in the attachment position is accessible from an outer side (A, B) of the chassis (2) so that it can be brought into the attachment position and removed from the attachment position from the outer side (A, B) of the chassis (2), the outer side (A, B) of the chassis (2) facing in a transverse direction (Y-Y) of the work machine (101; 201), the transverse direction (Y-Y) being perpendicular to the longitudinal direction (X-X).

2. The work machine (101; 201) as claimed in claim 1, wherein the propulsion motor (50) is coupled to the drive axle via a mechanical transmission (70).

3. The work machine (101; 201) as claimed in claim 2, wherein the mechanical transmission (70) comprises a transfer box (71) and a transmission shaft (3D; 4D), the transfer box (71) comprising an output shaft and an input shaft, the output shaft being coupled to the drive axle via the transmission shaft and being rotatable about a first axis of rotation (R1; R1S) included in a reference plane (P), the reference plane (P) being parallel to the longitudinal direction (X-X) and to the transverse direction (Y-Y), the input shaft being coupled to the propulsion motor (50) and being rotatable about a second axis of rotation (R2), and wherein an angle (B) between the reference plane (P) and a straight line (D) intersecting the first axis of rotation (R1) and the second axis of rotation (R2) is between 0° and 30°.

4. The work machine (101; 201) as claimed in claim 3, wherein the second axis of rotation (R2) is included in the reference plane (P).

5. (canceled)

6. The work machine (101; 201) as claimed in any one of the claims 1 to 4, wherein the chassis (2) comprises a first longitudinal side member and a second longitudinal side member, the first longitudinal side member and the second longitudinal side member being parallel to each other and extending parallel to the longitudinal direction (X-X), and wherein, in the attachment position, at least a part of the frame (40) projects from the first longitudinal side member in the transverse direction (Y-Y) in a direction away from the second longitudinal side member, said outer side (A, B) of the chassis (2) facing in said direction away from the second longitudinal side member.

7. The work machine (101; 201) as claimed in claim 6, wherein the power supply unit (30) comprises three attachment portions (41, 42, 43; 541, 542, 543; 444, 445, 446; 644, 645, 646),
wherein the attachment portions (41, 42, 43; 541, 542, 543; 444, 445, 446; 644, 645, 646) comprise:
at least one outer attachment portion (41, 42; 541, 542; 444; 644), the at least one outer attachment portion (41, 42; 541, 542; 444; 644) in the attachment position being located to the outside of the first longitudinal side member in the transverse direction (Y-Y) in a direction away from the second longitudinal side member; and
at least one inner attachment portion (43; 543; 445, 446; 645, 646), the at least one inner attachment portion (43; 543; 445, 446; 645, 646) in the attachment position being located on the opposite side, in the transverse direction (Y-Y), of the first longitudinal side member from the at least one outer attachment portion (41, 42; 541, 542;

8. The work machine (101; 201) as claimed in claim 7, wherein the attachment portions (41, 42, 43; 541, 542, 543) comprise:
two outer attachment portions (41, 42; 541, 542), the outer attachment portions (41, 42; 541, 542) in the attachment position being located to the outside of the first longitudinal side member in the transverse direction (Y-Y) in a direction away from the second longitudinal side member.

9. The work machine (101; 201) as claimed in claim 8 in combination with any one of claims 3 to 4, wherein the transfer box (71) has a casing (72) fixed to the frame (40), and the inner attachment portion (43) is attached to the casing (72).

10. The work machine (101; 201) as claimed in claim 7, wherein the attachment portions (444, 445, 446; 644, 645, 646) comprise:
two inner attachment portions (445, 446; 645, 646), the inner attachment portions (445, 446; 645, 646) in the attachment position being located on the opposite side, in the transverse direction (Y-Y), of the first longitudinal side member from the outer attachment portion 644).

11. The work machine (101; 201) as claimed in claim 10 in combination with any one of claims 3 to 4, wherein, in the attachment position, the inner attachment portions (445, 446; 645, 646) are located between the first longitudinal side member and the second longitudinal side member in the transverse direction (Y-Y), and the transfer box (71) is located between the inner attachment portions (445, 446; 645, 646) in the longitudinal direction (X-X).

12. The work machine (101) as claimed in any one of claims 6 to 11, wherein the work machine (101) further comprises a cab (96) for an operator of the work machine, the cab (96) being disposed between the front axle (3) and the rear axle (4) in the longitudinal direction (X-X), and the cab (96) projecting beyond the second longitudinal side member (2-2) in the transverse direction (Y-Y) in a direction away from the first longitudinal side member (2-1).

13. The work machine (201) as claimed in any one of claims 6 to 11, wherein the work machine (201) further comprises a cab (96) for an operator of the work machine, the cab (96) being disposed between the front axle (3) and the rear axle (4) in the longitudinal direction (X-X), and the cab (96) projecting beyond the first longitudinal side member (2-2) in the transverse direction (Y-Y) in said direction away from the second longitudinal side member (2-1), and wherein the frame (40) in the attachment position is situated lower down than the cab (96) in a vertical direction (Z-Z) of the work machine (201), the vertical direction (Z-Z)-being perpendicular to the longitudinal direction (X-X) and to the transverse direction (Y-Y).

14. The work machine (101; 201) as claimed in any one of claims 6 to 13, wherein each of the attachment portions (41, 42, 43; 444, 445, 446; 541, 542, 543; 644, 645, 646) comprises a vibration damping element (41A, 42A, 43A).

15. The work machine (101; 201) as claimed in any one of claims 1 to 14, wherein the power supply unit (30) comprises a hydraulic pump (65), the actuator is a hydraulic cylinder (97A, 98A, 99A), and the hydraulic pump (65) is configured to drive the hydraulic cylinder (97A, 98A, 99A).

16. The work machine (101; 201) as claimed in claim 15, further comprising a lifting arm (98) articulated to the chassis (2), the lifting arm (98) functioning as the handling member, and wherein the hydraulic cylinder is a lifting cylinder (98A) for lifting the lifting arm (98), a first end of the lifting cylinder (98A) being articulated to the chassis (2) and a second end of the lifting cylinder (98A) being articulated to the lifting arm (98).
